(19) United States
(12) Patent Application Publication
(10) Pub. No.: US 2002/0053003 A1
(43) Pub. Date: May 2, 2002

(54) System and method for implementing behavioral operations

(76) Inventor: Christopher Lockton Brandin, Colorado Springs, CO (US)

Correspondence Address: Law Offices of Dale B. Halling, Suite 311, 24 South Weber St., Colorado Springs, CO, 80903, US

(21) Appl. No.: 09/977,266

(22) Filed: Oct. 12, 2001

Related U.S. Application Data
(60) Provisional application No. 60/240,028, filed on Oct. 13, 2000.

(51) Int. Cl. G06F 12/00

(52) U.S. Cl. 711/108

(57) ABSTRACT

A system (330) for implementing behavioral operations includes a search engine (332) connected to an input data. An associative match memory (334) is connected to the search engine (332). A behavioral operation unit (336) is connected to the associative match memory.

### RELATED APPLICATIONS

This patent claims priority on the provisional patent application entitled “Behavioral Set and Field Descriptor Implementations in DPP”, Ser. No. 60/240,028, filed Oct. 13, 2000, assigned to the same assignee as the present application.

### FIELD OF THE INVENTION

The present invention relates generally to the field of computer searching systems and more particularly to a system and method of behavioral operations.

### BACKGROUND OF THE INVENTION

It is commonly required in computers to find a particular string of data. For instance, a user might want to identify all of his documents that have a particular word. The computer creates a window the size of the word and starts searching all the files on the computer's hard disk for the word. Another example is firewalls and anti-virus programs. Unfortunately, the user might be looking for several words of differing lengths or signatures having different lengths. As a result the computer has to create search windows of differing lengths. Assume one search window is three bytes and a second window is four bytes. We have to form two comparisons for each new byte of data. One comparison that contains the new byte of data and two old bytes of data and a second comparison that contains the new byte of data and three old bytes of data. This is a very processor intensive process. Note that if several three byte words (addresses) are being search for, the process requires a comparison for each of these words.

In addition to these problems it often happens that the items being searched for is not the final item required, but a trigger for the search to proceed in another direction or under different circumstances (behavior). For instance, network data is often contained in packets. The information that the user wants to scan is contained in the data portion of the packet, however it is common to have multiple types of packets encased in the packet. The search has to skip over the header information for all the encapsulated packets and find the actual data. Present solutions to this problem use groups of finite state machines (FSA—finite state automata). Unfortunately, when the number of possibilities to be examined expands the number of FSAs and their connections grow exponentially. This means that the programmers' efforts grow exponentially and the possibility of mistakes grow exponentially.

Thus there exists a need for a search process has the flexibility to deal with complex searching problems.

### BRIEF DESCRIPTION OF THE DRAWINGS

FIG. 1 is a schematic diagram of a sliding window search routine in accordance with one embodiment of the invention;

FIGS. 2 & 3 are a flow chart of the steps used in performing a sliding window search in accordance with one embodiment of the invention;

FIGS. 4 & 5 are a flow chart of the steps used in performing a sliding window search in accordance with another embodiment of the invention;

FIG. 6 is a flow chart of the steps used in performing a sliding window search in accordance with another embodiment of the invention;

FIG. 7 is a flow chart of the steps used in an icon shift function in accordance with one embodiment of the invention;

FIG. 8 is a flow chart of the steps used in an icon unshift function in accordance with one embodiment of the invention;

FIG. 9 is a flow chart of the steps used in a transform function in accordance with one embodiment of the invention;

FIG. 10 is a flow chart of the steps used in an untransform function in accordance with one embodiment of the invention;

FIG. 11 is an example of a transform lookup table;

FIG. 12 is an example of a transform translation table;

FIG. 13 is a block diagram of a system for associative processing in accordance with one embodiment;

FIG. 14 is a linear feedback register used to calculate an icon (CRC, polynomial code) in accordance with one embodiment of the invention;

FIG. 15 is a block diagram of a system for associative processing in accordance with one embodiment;

FIG. 16 is a block diagram of a system for implementing behavioral operations in accordance with one embodiment of the invention;

FIG. 17 is a block diagram of a system for implementing behavioral operations in accordance with one embodiment of the invention;

FIG. 18 is an example of a behavioral operation;

FIG. 19 is a flow chart of the steps used in a method of behavioral operation of a data document in accordance with one embodiment of the invention; and

FIG. 20 is a flow chart of the steps used in a method of behavioral operation of a data document in accordance with one embodiment of the invention.

### DETAILED DESCRIPTION OF THE DRAWINGS

A system for implementing behavioral operations includes a search engine connected to an input data. An associative match memory is connected to the search engine. A behavioral operation unit is connected to the associative match memory.

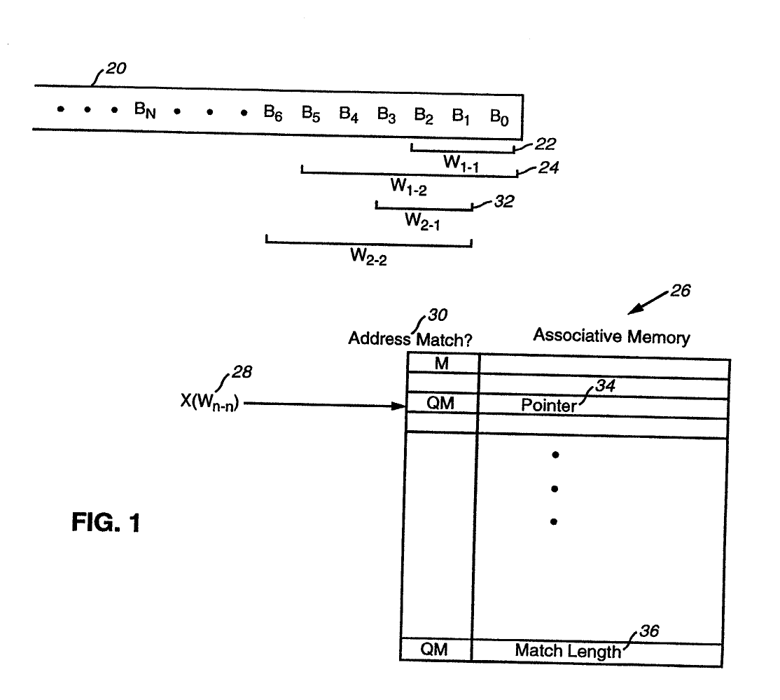

FIG. 1 is a schematic diagram of a sliding window search routine in accordance with one embodiment of the invention. A data block 20 to be searched is represented as B₀, B₁, B₂-Bₙ, where B₀ may represent a byte of data. A first window 22 (W₁₋₁) has a search window size of three bytes. The search window size, in one embodiment, is equal to the size of one of the plurality of data strings for which we are searching. Another window 24 (W₂₋₁) has a search window size of five bytes. An associative database (associative memory) 26 consists of a plurality of address {X(Wₙ₋ₙ)} 28. In one embodiment, the transform of each of the plurality of data strings corresponds to one of the addresses 28 of the associative memory 26. In another embodiment, a transform for at least a first portion of each of the plurality of data strings corresponds to one of the addresses 28 of the associative memory 26. In one embodiment, the transform is a cyclical redundancy code for the plurality of data strings or first portion of the plurality of data strings. In another embodiment, the transform is any linear feedback shift register transformation (polynomial code) of the data string. Generally the polynomial code is selected to have as few collisions as possible.

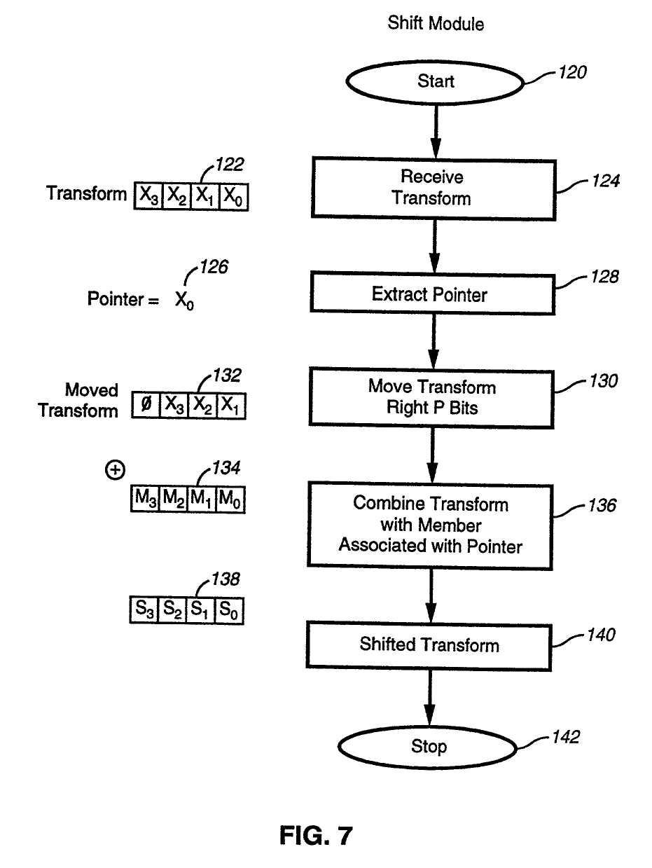

In one embodiment, a transform (icon) is determined for the first window 22 {X(W₁₋₁)}. Then the address 28 in the associative database equal to the first window transform is queried. The first entry at the address is a match indicator 30. There are three possible states for the match: no match, match (M) and qualified match (QM). When a match occurs this information is passed to a user (operating system) for further processing. When a no match state is found the window slides by one byte for example. This is shown as window W₂₋₁ 32. The subscript one means its the first size window (three byte size) and the subscript two means its the second window. Note the window has slid one byte to cover bytes B₁, B₂, B₃. Prior art techniques, such as hashing, would require determining a completely new transform for the bytes B₁, B₂, B₃. The present invention however uses advanced transform techniques for linear feedback shift registers that are explained in the patent application entitled “Method and Apparatus for Generating a Transform”; Ser. No. 08/613,037; filed Mar. 8, 1997; assigned to the same assignee as the present application and incorporated herein by reference. These advanced transform techniques are also explained in detail with respect to FIGS. 7-11. Using these advanced techniques a transform (first byte icon) is calculated for a first byte of data (B₀). An icon shift function is performed on the first byte icon to form a shifted first byte icon. Note the shifted first byte icon is X(B₀ 0 0) in this case, where 0 0 represents two bytes of zeros. Note that this discussion also assumes that B₀ is the highest order byte.

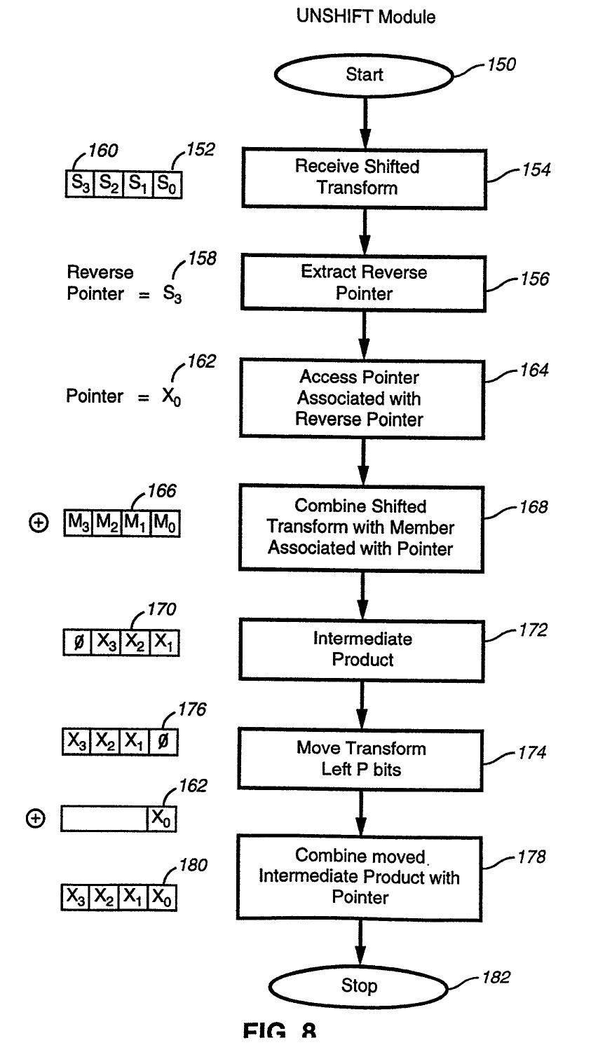

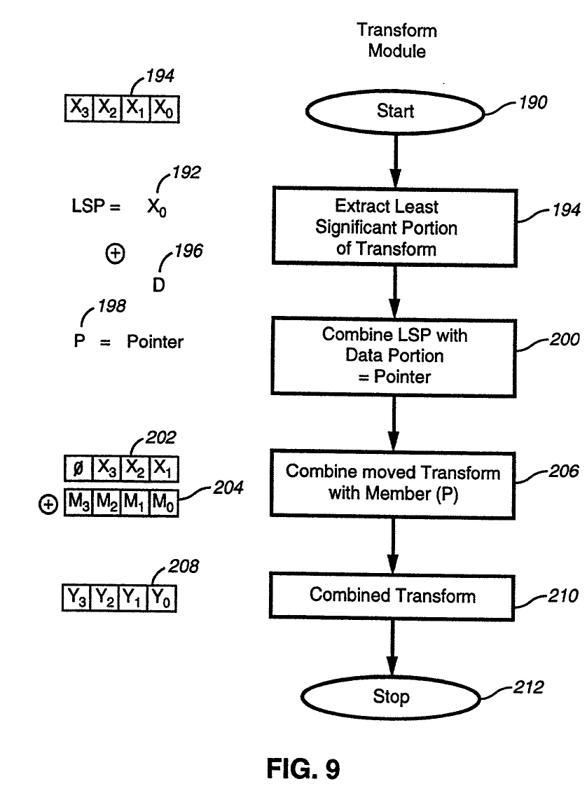

The shifted first byte icon X(B₀ 0 0) is exclusive ORed with the first icon X(B₀ B₁ B₂) to form a seed icon X(B₁ B₂). Next a second icon X(B₁ B₂ B₃) is formed by transforming a new byte of data (B₃) onto the seed icon X(B₁ B₂). The process of transforming a new byte of data onto an existing transform is explained with respect to FIG. 9. In another embodiment, the seed icon is icon shifted to form a shifted seed icon X(B₁ B₂ 0). The shifted seed icon X(B₁ B₂ 0) is exclusive ORed with the icon for the new byte of data X(B₃) to form the second icon X(B₁ B₂ B₃). Now the second icon represents an address in the associative memory, so we can determine if there is a match for the data (B₁ B₂ B₃). This process then repeats for each new byte of data.

Using this process significantly reduces the processing time required to determine a match. Note that if the process is searching for several three bytes strings it requires the same number of steps as searching for a single three byte string of data. This is because each new data string just represents a different entry in the associative database 26. Whereas standard compare functions would have to perform a comparison for each data string being searched. Thus this invention is particularly helpful where numerous data strings need to be matched.

Often the data strings for which we are searching have differing lengths. In one embodiment this is handled by defining a separate window search size (e.g., W₂₋₁ 24). The two or more window sizes operate completely independently as described above. In another embodiment, the associative database 26 contains a qualified match for a first portion of each the data strings that are longer than the window length. Note in this case the window length (window size) is selected to be equal to the shortest data string being searched. When the process encounters a qualified match, two alternative implementations are possible. In one implementation, there is a pointer 34 associated with the qualified match. The pointer points to a second icon. The process determines an icon for a next window of data. When the icon for the next window of data matches the second icon a match has been found. Note that this technique can be extended for data strings that have sizes that are many times longer than the window size. However, this implementation is limited to data sizes that are multiples of the window size. This may be limiting in some situations. The second implementation has a match length 36 associated with the qualified match. The match length indicates the total length of the data string to be matched. Then an icon can be determined for the complete data string or for just that portion of the data string that does not have an icon. Using this icon the process can determine if there is match. Using these methods it is possible to handle searches for data strings having varying lengths. This method provides a significant improvement over comparison search techniques, that have to perform multiple comparisons on the same data when differing window lengths are involved.

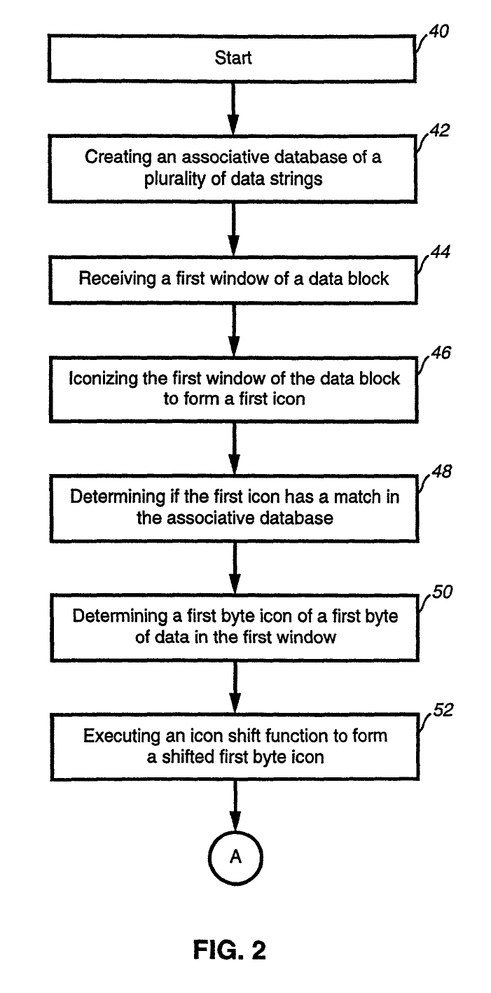

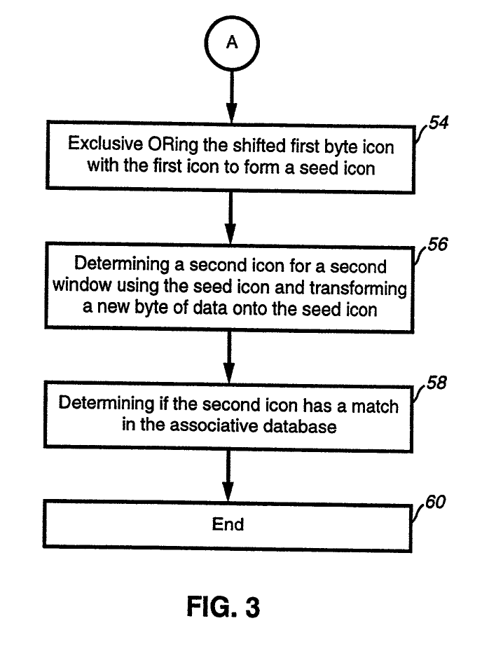

FIGS. 2 & 3 are a flow chart of the steps used in performing a sliding window search in accordance with one embodiment of the invention. The process starts, step 40, by creating an associative database of a plurality of data strings at step 42. A first window of a data block is received at step 44. The first window of the data block is iconized to form a first icon at step 46. Next it is determined if the first icon has a match in the associative database at step 48. A first byte icon is determined for the a first byte of data in the first window at step 50. An icon shift function is executed to form a first byte icon at step 52. The shifted first byte icon is exclusive ORed with the first icon to form a seed icon at step 54. A second icon is determine for a second window using the seed icon and transforming a new byte of data onto the seed icon at step 56. At step 58 it is determined if the second icon has a match in the associative database which ends the process at step 60. The process just repeats until the whole block of data has been analyzed for matches. Note the process described above assumes that second window has been shifted one byte from the first window. It will be apparent to those skilled in the art the process can be easily modified to work for shifts of one bit to many bytes. The process described above also assumes that the window is larger than a single byte. However, the process would work for a single byte.

In another embodiment, the process first determines if a single search window size is required. When only a single window search size is required an icon is determined for each of the plurality of data strings. When more than a single window search size is required, a minimum length search window is determined. Next an icon is calculated for each of a first plurality of data strings having a length equal to the minimum length, to form a plurality of first icons. The plurality of first icons are stored in the associative database. Next an icon is calculated for a first portion of each of a plurality of data strings, to form a plurality of second icons. The plurality of second icons are stored in the associative database. An icon is calculated for a second portion of each of the second plurality of data strings to form a plurality of third icons. The plurality of third icons are stored in the associative database. A pointer is stored with each of the second icons that points to the one of the plurality of third icons. Note that in one embodiment a match flag is stored at an address corresponding to the icons (first icons, second icons, third icons).

In another embodiment, when the process finds that the first icon is found in the associative database, it is determined if a pointer is stored with the first icon. When a pointer is not stored with the first icon, then a match has been found. When a pointer is stored with the first icon a next icon is determined. The next icon is the transform for the next non-overlapping window of the data block being searched. The next icon is compared to the an icon at the pointer location. When the next icon is the same as the icon at the pointer location a match has been found.

In another embodiment when the first icon is found in the associative database and includes a pointer, a second icon is determined. Next it is determined if the second icon has a matching the associative database. In another embodiment the second icon is determined using an icon append operation with a second portion to the first icon. The second portion is the next non-overlapping window of data in the data block being searched.

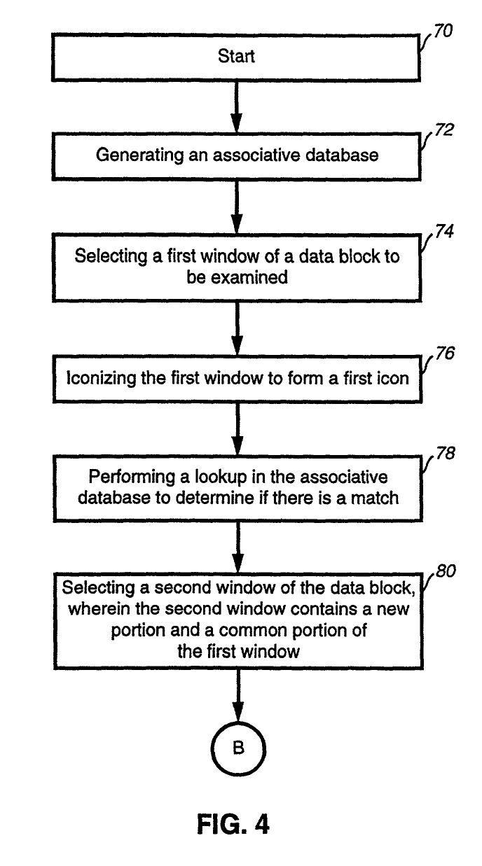

FIGS. 4 & 5 are a flow chart of the steps used in performing a sliding window search in accordance with another embodiment of the invention. The process starts, step 70, by generating an associative database at step 72. A first window of a data block is selected to be examined at step 74. The first window is iconized to form a first icon at step 76. A lookup in the associative database is performed to determine if there is a match at step 78. A second window of the data block is selected, wherein the second window contains a new portion and a common portion of the first window at step 80. A second icon is determined using the first icon, a discarded portion and the portion but not the common portion at step 82. The second icon is associated with the second window which ends the process at step 84. In one embodiment, this process is repeated until the complete data block has been examined. In another embodiment the process of forming an icon involves a linear feedback shift register operation. In another embodiment the linear feedback shift register operation is a cyclical redundancy code.

In another embodiment the process of forming the second icon includes determining a discarded icon for the discarded portion. Then an icon shift function is executed to form a shifted discarded icon. The shifted discarded icon is exclusive ORed with the first icon to form a seed icon. A new icon is determined for the new potion. The new icon is exclusive ORed with the seed icon to form the second icon.

In another embodiment the lookup process to determine if there is a match includes determining if the associative database indicates a match, a no match or a qualifier match. When a qualifier match is indicated, a next window icon for the next complete non-overlapping window of data is determined. Then it is determined if there is a pointer pointing from the first icon to the next window icon.

In another embodiment, when a qualifier match is indicated, a match length is determined. An extra portion is appended onto the first icon to form a second icon. Note the extra portion of the data plus the window of data that has been iconized is equal to the match length. Using the second icon it is determine if the associative database indicates a match.

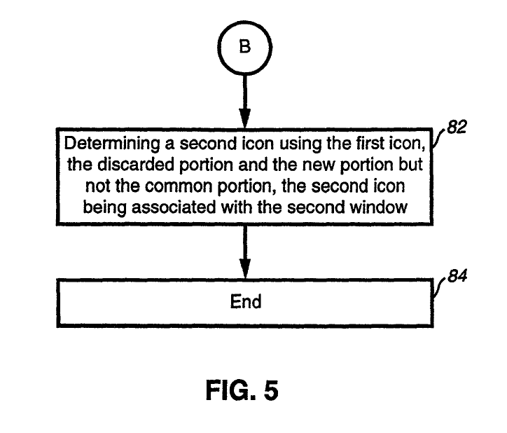

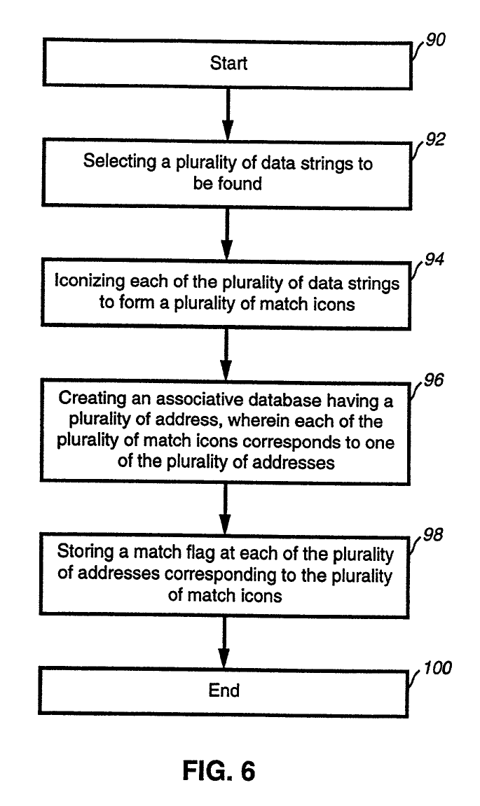

FIG. 6 is a flow chart of the steps used in performing a sliding window search in accordance with another embodiment of the invention. The process starts, step 90, by selecting a plurality of data strings to be found at step 92. The plurality of data strings are iconized to form a plurality of match icons at step 94. An associative database is created having a plurality of icons, wherein each of the match icons corresponds to one of the plurality of addresses at step 96. At step 98, a match flag is stored at each of the plurality of addresses corresponding to the plurality of match icons which ends the process at step 100. When the plurality of data strings do not all have a same length a plurality of shortest data strings are selected. A plurality of short icons associated with the shortest data strings are determined. The match indicator is stored in the associative database at the address associated with each of the short icons. A plurality of qualifier icons are determined for a first portion of a plurality of longer data strings. A qualifier flag is stored in the associative database for each of the qualifier icons. A match length indicator is stored with each of the qualifier icons in the associative database. An icon is determined for a first window of a data block, wherein the first window has a window length equal to a shortest length. A lookup is performed in the associative database to determine if there is a match flag or a qualifier flag. When there is a qualifier flag, the match length indicator is retrieved. A complete icon is determined for the portion of the data block equal to the match length. A lookup is performed to determine if there is a match flag associated with the complete icon.

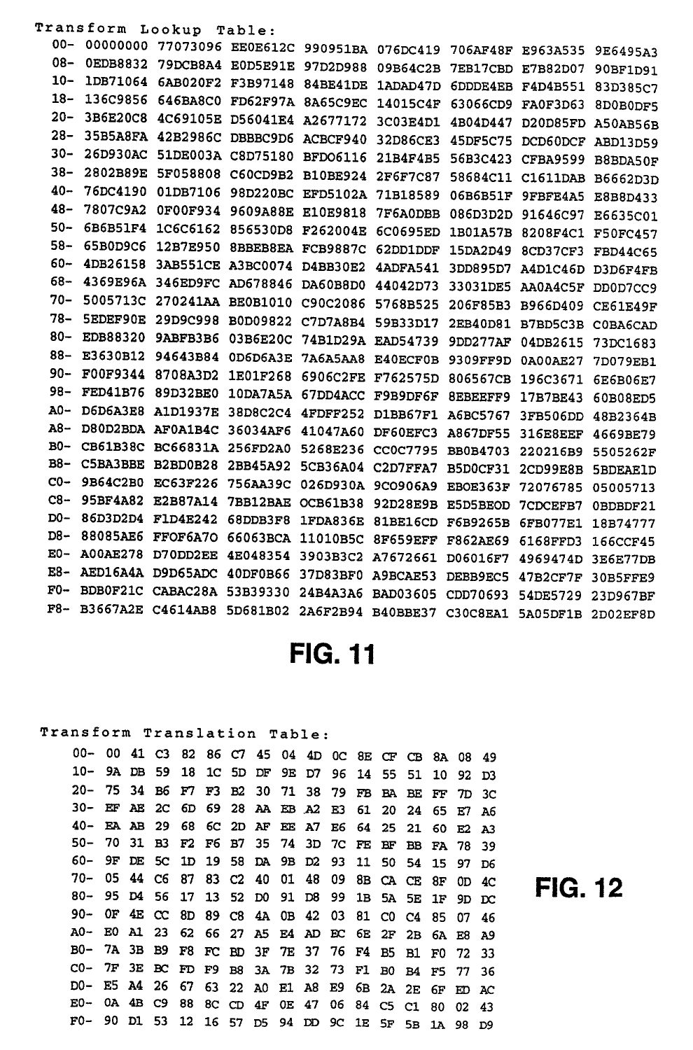

The following figures explain the “icon algebra” used in implementing the invention. FIG. 7 is a flow chart of the steps used in an icon shift function in accordance with one embodiment of the invention. The shift module determines the transform for a shifted message (i.e., “A0” or X^{Z}A(x)). Where X^{Z} means the function is shifted by z places (zeros) and A(x) is a polynomial function. The process starts, step 120, by receiving the transform 122 to be shifted at step 124. Next the a pointer 126 is extracted at step 128. The transform 122 is then moved right by the number of bits in the pointer 126, at step 130. This forms a moved transform 132. Note the words right and left are used for convenience and are based on the convention that the most significant bits are placed on the left. When a different convention is used, it is necessary to change the words right and left to fit the convention. Next the moved transform 132 is combined (i.e., XOR'ed) with a member 134 associated with the pointer 126, at step 136. The member associated with the pointer is found in a transform look table, like the one shown in FIG. 11. Note that this particular lookup table is for a CRC-32 polynomial code, however other polynomial codes can be used and they would have different lookup tables. This forms the shifted transform 138 at step 140, which ends the process at step 142. Note that if the reason for shifting a first transform is to generate a first-second transform then first transform must be shifted by the number of bits in a second data string. This is done by executing the shift module X times, where X is equal to the number of data bits in the second data string divided by the number of bits in the pointer. Note that another way to implement the shift module is to use a polynomial generator. The first transform 122 is placed in the intermediate remainder register. Next a number of logical zeros (nulls) equal to the number of data bits in second data string are processed.

FIG. 8 is a flow chart of the steps used in an icon unshift function in accordance with one embodiment of the invention. An example of when this module is used is when the transform for the data string “AB” is combined with the transform for the data string “B”. This leaves the transform for the data string “A0” or X^{Z}A(x). It is necessary to “unshift” the transform to find the transform for the data string “A”. The process starts, step 150, by receiving the shifted transform 152, at step 154. At step 156 a reverse pointer 158 is extracted. The reverse pointer 158 is equal to the most significant portion 160 of the shifted transform 152. The reverse pointer 158 is associated with a pointer 162 in the reverse look up table (e.g., see FIG. 12) at step 164. Next, the member 166 associated with the pointer 162 in the table of FIG. 11 for example, is combined with the shifted transform at step 168. This produces an intermediate product 170, at step 172. At step 174 the intermediate product 170 is moved left to form a moved intermediate product 176. The moved intermediate product 176 is then combined with the pointer 162, at step 178, to form the transform 180, which ends the process, step 182. Note that if the number of bits in the “B” data string (z) is not equal to the number of bits in the pointer then the unshift module is executed X times, where X=z/(number of bits in pointer).

FIG. 9 is a flow chart of the steps used in a transform function in accordance with one embodiment of the invention. The transform module can determine the first-second transform for a first-second data string given the first transform and the second data string, without first converting the second data string to a second transform. The process starts, step 190, by extracting a least significant portion 192 of the first transform 194 at step 194. This is combined with the second data string 196 to form a pointer 198, at step 200. Next a moved first transform 202 is combined with a member 204 associated with the pointer in the look up table (e.g., FIG. 11), at step 206. A combined transform 208 is created at step 210 which ends the process, step 212. Note that if the pointer is one byte long then the transform module can only process one byte of data at a time. When the second data string is longer than one byte then the transform module is executed one data byte at a time until all the second data string has been executed. In another example assume that first transform is equal to all zeros (nulls), then the combined transform is just the transform for the second data string. In another embodiment the first transform could be a precondition and the resulting transform would be a precondition-second transform. In another example, assume a fourth transform for a fourth data string is desired. A first data portion (e.g., byte) of the fourth data string is extracted. This points to a member in the look up table. When the fourth data string contains more than the first data portion, the next data portion is extracted. The next data portion is combined with the least significant portion of the member to form a pointer. The member is then moved right by the number of bits in the next data portion to form a moved member. The moved member is combined with a second member associated with the pointer. This process is repeated until all the fourth data string is processed.

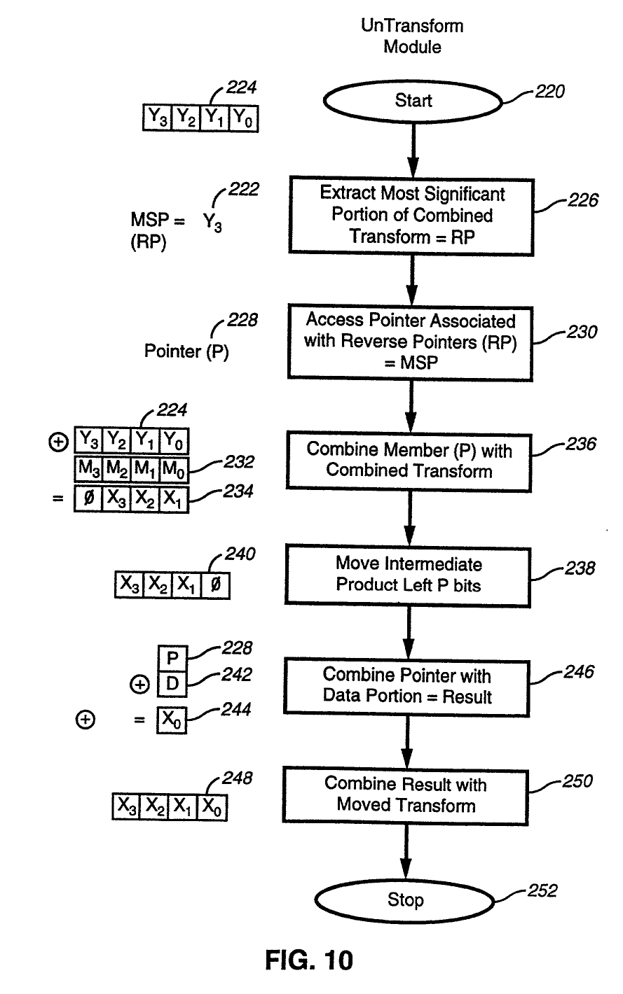

FIG. 10 is a flow chart of the steps used in an untransform function in accordance with one embodiment of the invention. The untransform module can determine the first transform for a first data string given the first-second transform and the second data string. The process starts, step 220, by extracting the most significant portion 222 of the first-second transform 224 at step 226. The most significant portion 222 is a reverse pointer that is associated with a pointer 228 in the reverse look-up table. The pointer is accessed at step 230. Next the first-second transform 224 is combined with a member 232 associated with the pointer to form an intermediate product 234 at step 236. The intermediate product is moved left by the number of bits in the pointer 228 at step 238. This forms a moved intermediate product 240. Next the pointer 228 is combined with the second data string 242 to form a result 244 at step 246. The result 244 is combined with the moved intermediate product 240 to form the first transform 248 at step 250, which ends the process at step 252. Again this module is repeated multiple times if the second data string is longer than the pointer.

Some examples of what the transform module 100 can do, include determining a second-third transform from a first-second-third transform and a first transform. The first transform is shifted by the number of data bits in the second-third data string. The shifted first transform is combined with the first-second-third transform to form the second-third transform. In another example, the transform generator could determine a first-second-third-fourth transform after receiving a fourth data string. In one example, the transform module would first calculate the fourth transform (using the transform module). Using the shift module the first-second-third transform would be shifted by the number of data bits in the forth data string. Then the shifted first-second-third transform is combined, using the combiner, with the fourth transform.

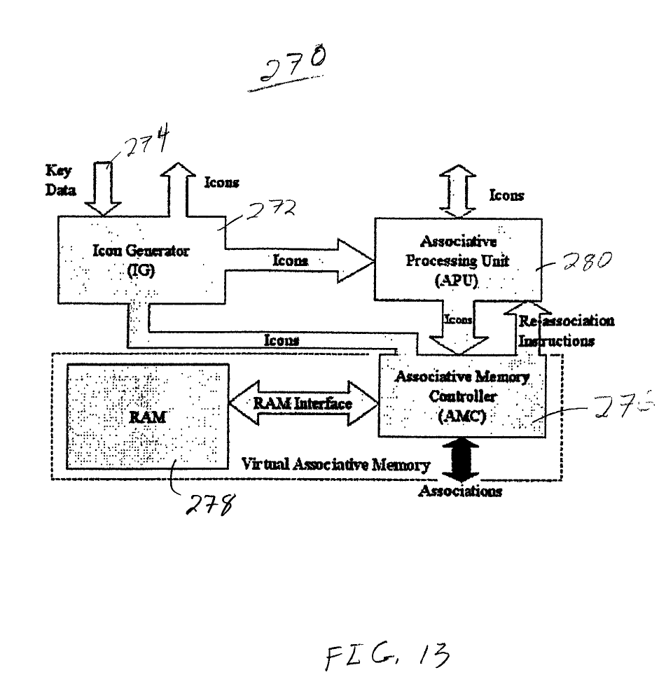

FIG. 13 is a block diagram of a system 270 for associative processing in accordance with one embodiment. The system 270 has an icon generator 272. The icon generator 272 has an input 274 connected to key data or input data that is converted to icons. The icon generator is connected to an associative memory controller 276. The associative memory controller (AMC) 276 receives icons from the icon generator 272. The associative memory controller 276 is connected to a RAM (random access memory; memory) 278. The AMC 276 and the RAM 278 form a virtual associative memory. The AMC 276 is connected to an associative processing unit 280. Note that the icon contains an address and a confirmer. The address is used to access the RAM 278 by the AMC 276. A confirmer from the address in the RAM is compared to the confirmer of the icon determine if a match has been found. For more information on the use of addresses and confirmers see U.S. Pat. No. 5,942,002 and U.S. patent application ser. No. 09/419,217 both assigned to the same assignee as the present application and hereby incorporated by reference.

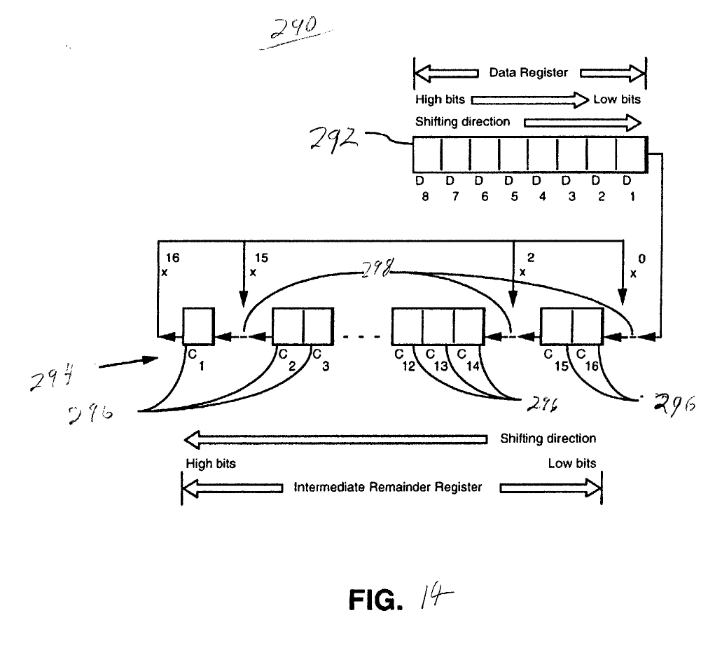

The icon generator may use a polynomial code to convert the key into an icon (or hash). The icon generator may also produce a plurality of lengths of icons. For more details on how the icon generator can produce multiple lengths of icons see U.S. patent application entitled “Method of Forming a Hashing Code”, Ser. No. 09/672,754, filed on Sep. 28, 2000 assigned to the same assignee as the present application and hereby incorporated by reference. The hardware to produce the icon may be linear feedback shift register (See FIG. 14) as used to produce CRCs (cyclical redundancy code). Or may be a microprocessor running the algorithms shown in FIGS. 9 & 12. Note that FIG. 12 is a lookup table.

The associative memory controller 276 may be a microprocessor that controls the functions of the RAM, such as lookups, stores, deletes, and comparing of confirmers. This list is not meant to be exhaustive just exemplary. The associative processing unit 280 may be a microprocessor. In addition the APU 280 may include shift registers and exclusive OR arrays. Among the functions the APU 280 might perform are the shift module, unshift module and untransform module shown in FIGS. 7, 8 & 10. In addition, any icon algebra that may be necessary. A formal treatment of the icon or linear algebra the APU 280 may perform is given in the appendix of the provisional patent application having Ser. No. 09/767,493, entitled “Definition of Digital Pattern Processing” filed on Oct. 13, 2000, and assigned to the same assigned as the present application and providing priority for the present application. A less formal and less complete treatment of the icon algebra is discussed in U.S. Pat. No. 5,942,002. In one embodiment, a single microprocessor may perform the functions of the IG 272, AMC 276 and APU 280.

FIG. 14 is a linear feedback register 290 used to calculate an icon (CRC, polynomiela code) in accordance with one embodiment of the invention. The icon generator 290 has a data register (shift register) 292 and an intermediate remainder register 294. The specific generator of FIG. 14 is designed to calculate a cyclical redundancy code (CRC-16). The plurality of registers 296 in the intermediate remainder register 294 are strategically coupled by a plurality of exclusive OR's 298. The data bits are shifted out of the data register 292 and into the intermediate register 294. When the data bits have been completely shifted into the intermediate register 294, the intermediate register contains the CRC associated with the data bits. Transform generators have also been encoded in software.

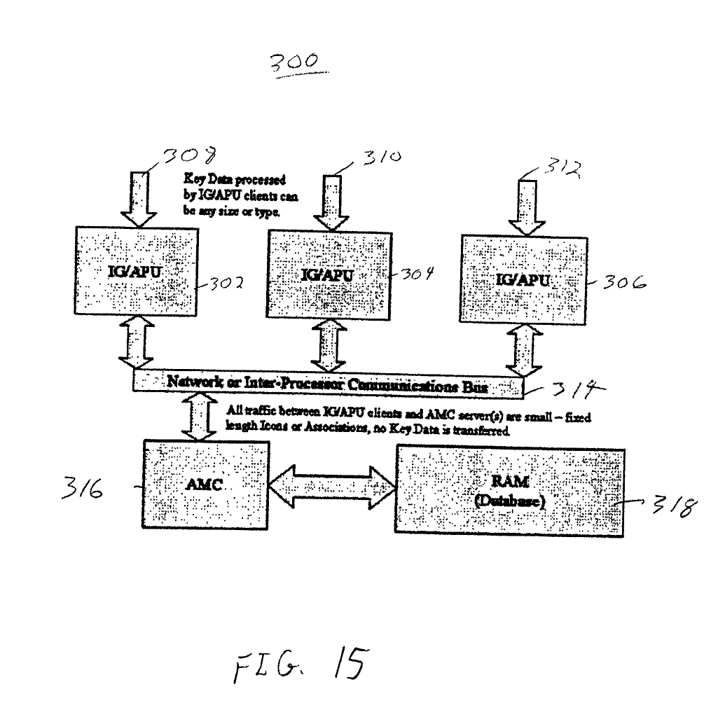

FIG. 15 is a block diagram of a system 300 for associative processing in accordance with one embodiment. The system 300 has multiple IG/APUs (icon generator/associative processing units; plurality of icon generators; plurality of associative processing units) 302, 304, 306. The IG/APUs 302, 304, 306 have an input connected to key data or input data streams 308, 310, 312. The IG/APUs are connected to a bus (network or inter-processor communication bus) 314. An AMC 316 is also connected to the bus 314. Generally, only icons of fixed length are passed over the bus 314. This significantly reduces the bus traffic and therefor the required bandwidth of the bus. The AMC 316 is connected to RAM 318 containing a database in one embodiment.

Thus there has been describe a system for associative processing that may be configured to perform any number of tasks including, associative databases, content scanning, packet accounting, extensible markup language database management systems and more.

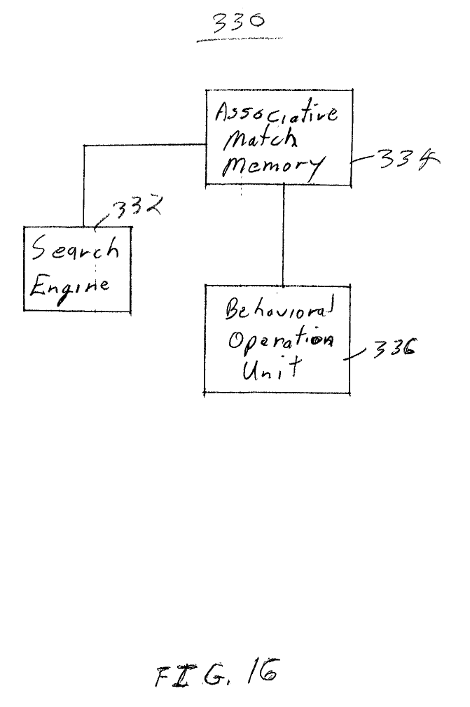

FIG. 16 is a block diagram of a system 330 for implementing behavioral operations in accordance with one embodiment of the invention. The system 330 has a search engine 332. The search engine 332 is connected to an associative match memory 334. A behavioral operation unit 336 is connected to the associative match memory 334. The operation of a search engine is explained with respect to FIGS. 1-6. The search engine can be implemented in software (firmware) or may be implemented in hardware. The behavioral operation unit 336 is implemented in memory and defines the behavior of the search engine 332.

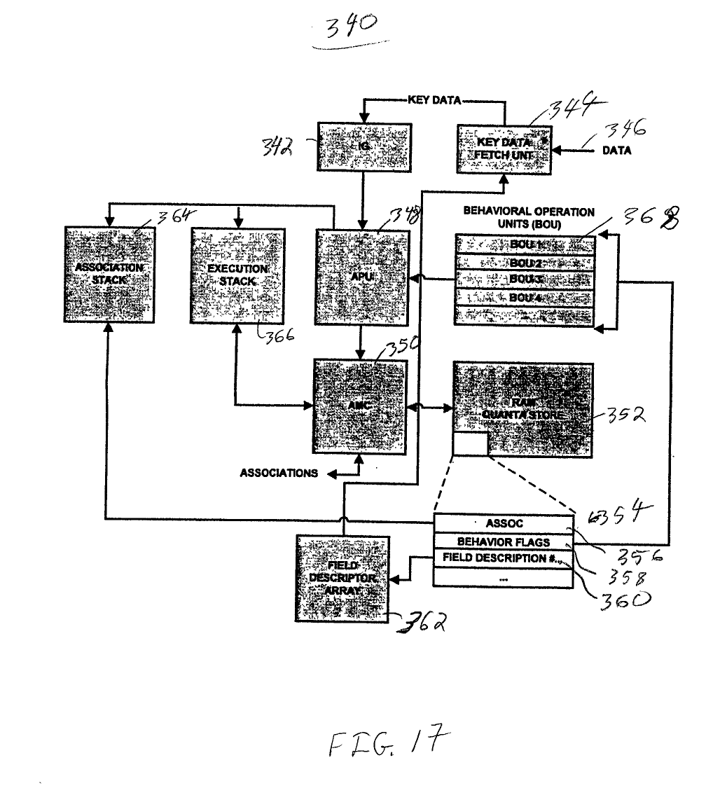

FIG. 17 is a block diagram of a system 340 for implementing behavioral operations in accordance with one embodiment of the invention. An icon generator 342 is connected to a key data fetch unit 344. The key data fetch unit 344 is connected to the input data 346. The icon generator 342 is connected to an associative processing unit (APU) 348. The APU 348 is connected to the associative memory controller (AMC) 350. The AMC 350 is connected to RAM 352 which stores quanta 354. The quanta 354 may contain an association 356, a behavioral flag (behavioral indicator) 358, field description numbers 360 and other information. The RAM 352 is connected to the field descriptor array 362. The RAM 352 is connected to an association stack 364. The AMC 350 is connected to an execution stack 366. The APU 348 is connected to the behavioral operation unit 368.

When the AMC 350 locates an association 356, one or more behavioral flags 358 are encountered. The AMC 350 receives the behavior flags 358 and the field descriptor 360 for processing. The APU 348 causes a new key data that is specified by the field data to be fetched by the key data fetch unit 344. The key data is then iconized by the IG 342. The APU 348 then executes the specific behavior specified by the behavioral flags 358. When a quanta contains a particular behavior flag it is said to belong to the set of quantas that have that behavior or belongs to a behavioral set. Behaviors are generally accommodated (implemented) by the use of logical operators, state machines or both. When a behavior flag is set, the corresponding behavior operational unit is activated. Certain behavior combinations are supported, so multiple behavioral operation units can be activated at the same time. Some behaviors involve iconizing new key data using the quantas's field descriptor to locate the key data. A field descriptor consists of a list of byte offsets and a mask for “don't care” bits.

There are two stacks in the system 340. The association stack 364 is used to hold possible association return values. For some operations, there is no way to determine which association to return until an association thread has been completed. For example, it is possible to have quanta that indicates it contains the return association (so it is pushed on the stack) unless a “better match” is found. The quanta would also contain a behavior flag that tells the APU how to go about finding a better match. If a better match is subsequently found, its return association value is pushed on the stack. Another behavior, for example, indicates than an exception to the current match condition may exist. If the exception is found, then the return association value at the bottom of the association stack is removed. When the thread is completed, the association return value at the bottom of the association stack is returned to the user.

The execution stack is used to optimize association thread performance. It allows thread execution to continue at a specified quanta in the event of a “dead end”. This happens, for example, if a match condition has multiple executions based on different field descriptors, and one of the exceptions has an exception to it (an exception to an exception). In this case, execution should continue at the first match conditions' quanta (not the preceding exceptions' quanta), in order to look for the next exception.

When an association thread is started, the user specifies a base set of field descriptors to begin with. As the association thread executes, other field descriptors are invoked by the field descriptor references contained in associated quantas.

The number of behaviors is not limited and may include almost any imaginable logical function. One of the behaviors is the association set. This indicates that the current quantas' association value should be pushed on to the association stack. Another behavior is the qualifier set. This indicates that additional key data should be iconized as specified in the referenced field descriptor and a subsequent lookup should be attempted. The possible effect of the next association is not known until it is found. Versions of the association set (M) and the qualifier set (QM) are explained with respect to FIGS. 1-6. Another behavior is the test set. This set contains an addition field for a score. As a thread is processed the association with the highest score is maintained. Any association that does not have a higher score is ignored. Another behavior is an exclusion set. This indicates that the quanta represents an exception, so the return association value at the bottom of the association stack is removed. Another behavior is the continuation set. This indicates that processing should continue.

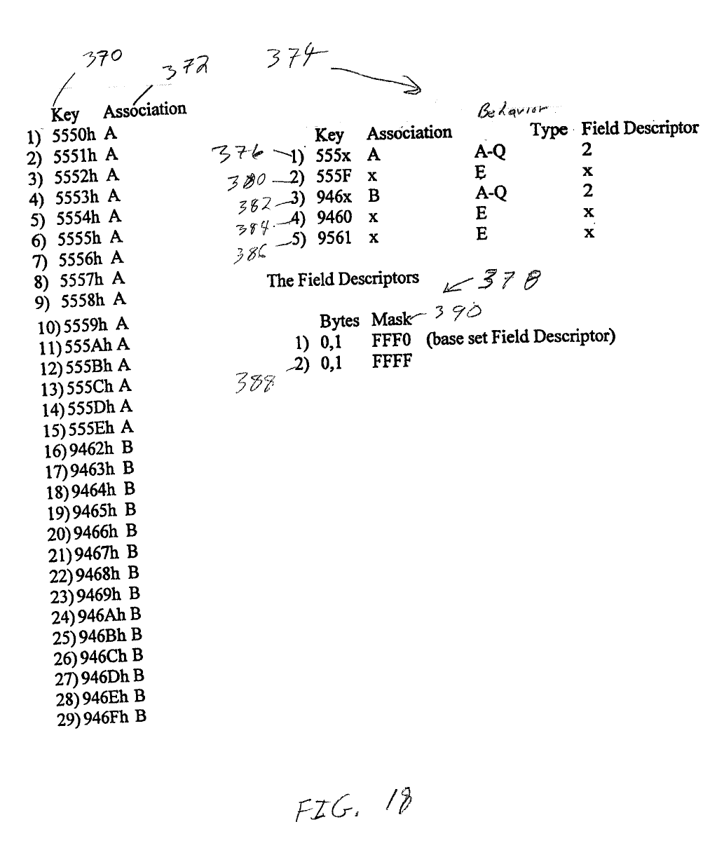

FIG. 18 is an example of a behavioral operation. Assume that a user wants to find the keys 370 with the associations 372. An associative memory with every entry could be created, however another alternative exists with behavioral sets. The keys 370 and associations 372 could be represented by the quantas 374. Note that the “x” indicates a don't care. The first quanta 376 indicates that the range of keys 5550-555F are potential matches. We know this because the behavior type (flag) is “A-Q”. The Q behavior tells us to investigate further using field descriptor “2”. The field descriptors 378 are listed below. The next quanta 380 shows that upon further investigation the key “555F” is excluded, but any of the other keys in the range will return the association “A”. Quantas 382, 384, 386 are used to define when the association “B” is returned. Note that field descriptor “2” 388 indicates an offset of “0” bytes or start at the zero byte and investigate to the first byte. The mask 390 indicates “FFFF” which means all bits in the two bytes are to be processed. A “0” bit would indicate a don't care bit. While more complex searches may be created using the system the example shows the power to reduces the number of quantas that have to be created. In this example the number of quantas was reduced from twenty-nine to six and this is just part of the power of the behavioral operation system.

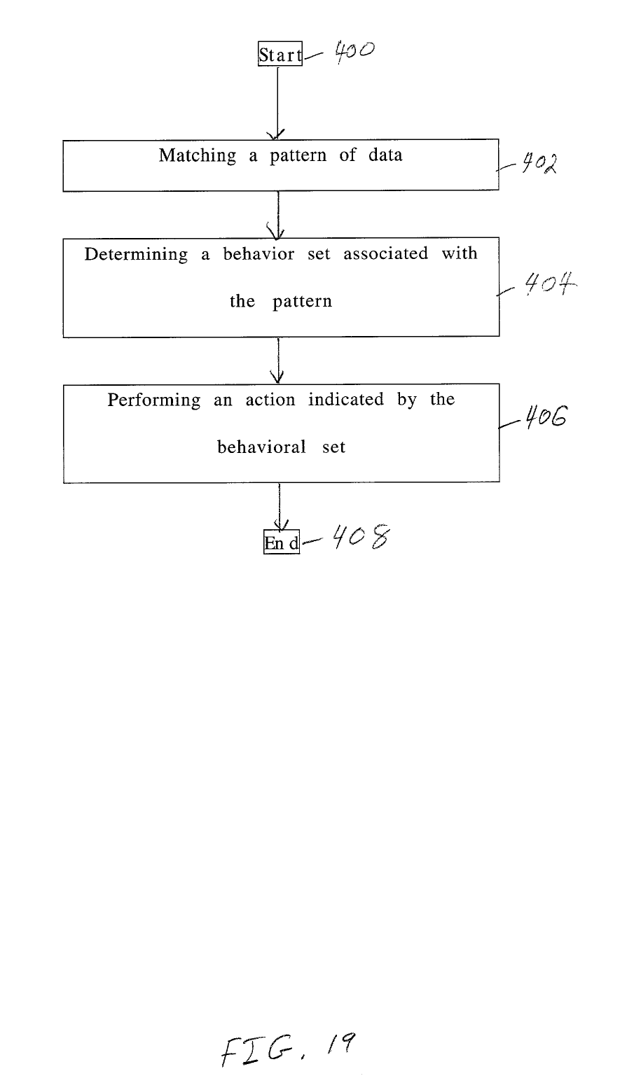

FIG. 19 is a flow chart of the steps used in a method of behavioral operation of a data document in accordance with one embodiment of the invention. The process starts, step 400, by matching a pattern of data at step 402. Next a behavior set associated with the pattern is determined at step 404. At step 406 an action indicted by the behavioral set is performed which ends the process at step 408. In one embodiment the step of matching a pattern of data includes determining an icon for the pattern. Next an associative lookup using the icon is performed to determine if a match exists. In one embodiment, the action performed may include storing an association and acquiring an information connected to the association. An association usually points to a location in a store where additional information about the match may be found. For instance, the pattern might be a customer's name. The association would point to a location in the store where the customer's address may be found. In another embodiment, the action may be determining a new field of data to be examined.

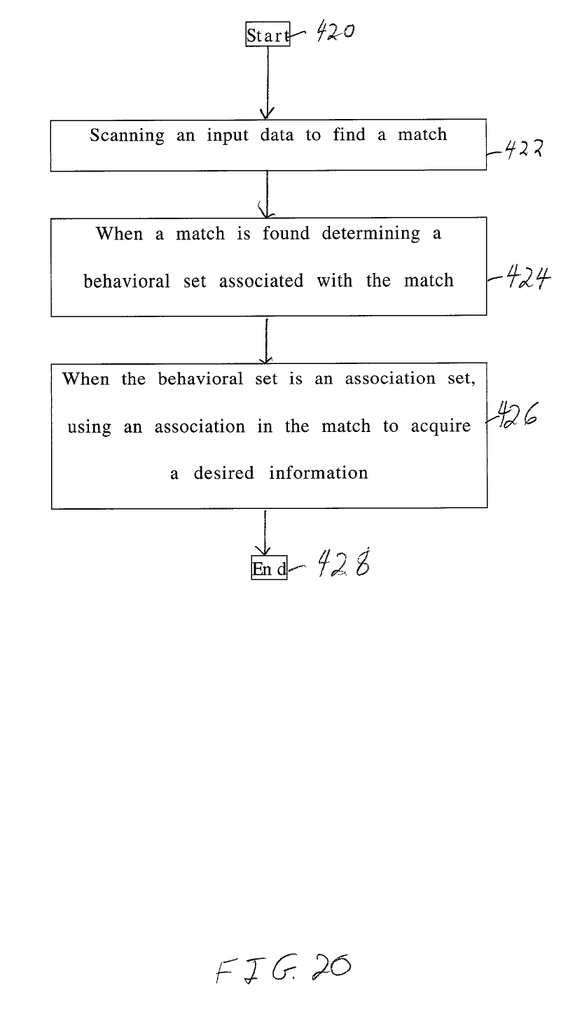

FIG. 20 is a flow chart of the steps used in a method of behavioral operation of a data document in accordance with one embodiment of the invention. The process starts, step 420, by scanning an input data to find a match at step 422. When a match is found, a behavioral set associated with the match is determined at step 424. When the behavioral set is an association set at step 426, an association in the match is used to acquire a desired information which ends the process at step 428. In one embodiment, when the behavioral set is a qualifier set, a field descriptor pointer is acquired. A field descriptor pointed to by the field descriptor pointer is looked up. A field to be examined is determined next. A mask associated with the field descriptor is applied to the field to form a masked field. The masked field is transformed (iconized) to determine if a second match is found. When a second match is found, a second behavioral set is determined and the process is repeated.

In one embodiment when the behavioral set is a test set, a score is acquired with the match. The score is compared to a previous score. When the previous score is lower than the score, a test association is examined. In one embodiment, the test association is pushed onto the association stack. When a previous score is not lower than the score, the test association is ignored.

When the behavioral set is an exclusion set, a present association is removed from an association stack. When the behavioral set is a continuation set, a related association is returned and processing continues. When the behavioral set is a stack set, a search is continued for a duplicate.

Thus there has been described a system and method for performing very complex searches with minimal effort on the part of the user. The searches may be complex enough to include non-traditional actions as a result of the search. In other words, the action may include operations other than just returning information. For instance, the action might be to stop processing a request.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A system for implementing behavioral operations, comprising:
a search engine connected to an input data;
an associative match memory connected to the search engine; and
a behavioral operation unit connected to the associative match memory.

2. The system of claim 1, further including a field descriptor array connected to the associative memory.

3. The system of claim 1, wherein the associative match memory includes an association and a behavioral indicator in an entry.

4. The system of claim 1, wherein the associative match memory includes a field descriptor in an entry.

5. The system of claim 3, wherein the behavioral indicator is an association set.

6. The system of claim 3, wherein the behavioral indicator is a qualifier set.

7. The system of claim 3, wherein the behavioral indicator is a test set.

8. The system of claim 7, wherein the test set includes a score field.

9. The system of claim 3, wherein the behavioral indicator is a stack set.

10. The system of claim 3, wherein the behavioral indicator is an exclusion set.

11. The system of claim 3, wherein the behavioral indicator is a continuation set.

12. The system of claim 2, wherein the field descriptor array includes a byte offset.

13. The system of claim 2, wherein the field descriptor array includes a mask.

14. A method of behavioral operation of a data document, comprising the steps of:
a) scanning an input data to find a match;
b) when a match is found determining a behavioral set associated with the match; and
c) when the behavioral set is an association set, using an association in the match to acquire a desired information.

15. The method of claim 14, further including the steps of:
d) when the behavioral set is a qualifier set, determining a field descriptor pointer;
e) looking up a field descriptor pointed to by the field descriptor pointer;
f) determining a field to be examined.

16. The method of claim 15, further including the steps of:
g) determining a mask associated with the field descriptor;
h) applying the mask to the field to form a masked field.

17. The method of claim 16, further including the steps of:
j) transforming the masked field to determine if a second match is found;
l) when the second match is found, determining a second behavioral set and repeating the process.

18. The method of claim 14, further including the steps of:
d) when the behavioral set is a test set, determining a score with the match;
e) comparing the score to a previous score;
f) when a previous score is lower than the score, examining an test association.

19. The method of claim 18, wherein step (f) includes the step of pushing the test association onto an association stack.

20. The method of claim 18, further including the step of:
g) when a previous score is not lower than the score, ignoring the test association.

21. The method of claim 14, further including the step of:
d) when the behavioral set is an exclusion set, removing a present association from an association stack.

22. The method of claim 14, further including the step of:
d) when the behavioral set is a continuation set, a related association is returned and processing continues.

23. The method of claim 14, further including the step of:
d) when the behavioral set is a stack set, continuing a search in an associative match memory for a duplicate.

24. A method of behavioral operation of a data document comprising the steps of:
a) matching a pattern of data;
b) determining a behavior set associated with the pattern; and
c) performing an action indicated by the behavioral set.

25. The method of claim 24, wherein step (a) further includes the steps of:
a1) determining an icon for the pattern;
a2) performing an associative lookup using the icon to determine if a match exists.

26. The method of claim 24, wherein step (c) further includes the steps of:
c1) storing an association;
c2) acquiring an information using the association.

27. The method of claim 24, wherein step (c) further includes the steps of:
c1) determining a new field of data to be examined.
